(19) United States
(12) Patent Application Publication
(10) Pub. No.: US 2014/0379803 A1
(43) Pub. Date: Dec. 25, 2014

(54) METHODS AND SYSTEMS FOR A MOBILE SOCIAL APPLICATION

(71) Applicant: Clint Russell Strand, Pflugerville, TX (US)

(72) Inventor: Clint Russell Strand, Pflugerville, TX (US)

(21) Appl. No.: 14/270,299

(22) Filed: May 5, 2014

Related U.S. Application Data
(60) Provisional application No. 61/837,956, filed on Jun. 21, 2013.

(51) Int. Cl. H04L 29/08

(52) U.S. Cl. CPC H04L 67/18; H04L 67/306
USPC 709/204

(57) ABSTRACT

Embodiments disclosed herein provide systems and methods for a social network that allows users to interact with each other based on their location and two users independently expressing interest in each other.

### CROSS-REFERENCE TO RELATED APPLICATIONS

This application claims a benefit of priority under 35 U.S.C. §119 to Provisional Application No. 61/837,956 filed on Jun. 21, 2013, entitled “METHODS AND SYSTEMS FOR A MOBILE SOCIAL APPLICATION,” which is fully incorporated herein by reference in its entirety.

### BACKGROUND INFORMATION

1. Field of the Disclosure

Examples of the present disclosure relate to techniques for mobile social networking. More particularly, embodiments may determine a location of a first user, present to the first user limited information associated with other users at the location, and allow the first user to communicate with other users at the location if both the first user and the other users have independently expressed interest in communicating with the first user.

2. Background

Individuals see other people that they desire to network with or that they are attracted to daily, such as at work, coffee shop, gym, bar, etc. However, individuals may be inhibited from approaching others that they desire to network with or that they are attracted. This may be because of the risk of rejection, timeliness, shyness, etc. In many situations, an individual may see another individual that they are attracted to and the other individual is also attracted to them. Yet, the two individuals may not approach each other for various reasons leading to a missed opportunity for the two to connect with each other.

Conventionally, individuals looking for a date may sign up for online dating sites. However, individuals may be reluctant to join an online dating site because it may feel unnatural, require individuals to express interest in others who may not reciprocate the interest, individuals may be inundated by connection requests from suitors that they are not interest in, etc. Furthermore, conventional online dating sites also require that individuals publish personal information that may be viewed by others, and the individuals may spend a significant amount of time managing online conversations, which may be an inefficient use of time to make a connection.

Accordingly, needs exists for more efficient networks that allows users to connect with each other, if two individuals are at the same location and independently express interest in each other.

### SUMMARY

Embodiments disclosed herein provide systems and methods for a social network that allows users to interact with each other based on their location and two users independently expressing interest in each other. In embodiments, client computing devices may facilitate connecting users at locations that they typically visit, while reducing or limiting the amount of profile information published to other users before two users independently express interest in each other. Embodiments may limit or reduce the risk of embarrassment, fear of rejection when trying to connect with another user, and/or the risk of being inundated with connection requests from other users that they do not desire to connect with.

In embodiments, a server may be configured to determine a location of a client computing device. Responsive to a user performing an action on the client computing device to check into the location or automatically determining the location of the client computing device, the server may communicate information corresponding to the user's profile to be presented to other users who are located at the same location or other users that are proximate to the location. In embodiments, the user's profile information may include a picture of the user, biographic information of the user, demographic information of the user, etc.

Responsive to the server determining that the user is no longer at the location or that the user has checked out of the location, the user's profile information may not be made available to other users at the location. Accordingly, the user's profile information may only be visible to other users while the user is at the location and the other users are at the location, the user and other users are checked into the location, and/or the user and other users proximately located to each other. Thus, users may learn basic information about other users at the location before deciding to interact with each other. However, the user's basic profile information may not be shared with everyone, only users that are proximately located to one another.

In embodiments, a first user of a first client computing device may view basic profile information associated with a list of users checked into the location of the first client computing device. The first user may enter commands on a graphical user interface of the first client computing device to transmit a connection request, wherein the connection request indicates that the first user desires to interact with a second user using a second client computing device. Without viewing or receiving any information associated with the connection request from the first client computing device, the second user may enter commands on a graphical user interface of the second client computing device to transmit a connection request, wherein the connection request indicates that the second user desires to interact with the first user.

In embodiments, responsive to the first and second users independently performing actions to transmit connection requests to connect with each other, a connection acceptation request may be transmitted to the first and second client computing devices indicating that the first and second users have independently expressed interest in each other, without knowledge that the other user has transmitted a connection request.

In embodiments, if the first and second users have independently transmitted communication requests expressing interest in each other, a connection between the users may be made. Responsive to a connection being made between the users, the users may have a textual, video, and/or audio based conversation without exchange contact information and/or adding them to a social media friend or connection list. Therefore, users may not make available their personal information or contact information to other users that they do not express interest in or that they are not at the same physical location. The users may later decide if they desire to become more acquainted with each other and exchange contact information within their profile information, download profile information associated with the user, and/or break the connection entirely without the other individual retaining their profile information or contact information.

In embodiments, if the first and second users have independent transmitting connection requests expressing interest in each other, and at least one of the first or second users checks out of the location and/or changes their location, then the connection between the two users may be terminated, and the users may not be able to communicate with each other using the server.

In embodiments, responsive to the first user transmitting a connection request to interact with the second user, an anonymous connection message may be transmitted the second user. The anonymous connection message may indicate that at least one other user at the location desires to interact with the second user. However, the anonymous connection message may not include any information associated with the first user that transmitted the connection request. Utilizing the anonymous connection request, the second user may be made aware of other users at the location desire to connect with the second user.

Accordingly, embodiments limit, reduce, or maintain anonymous profile information of a user until the user and another user independently express interest in each other. This may reduce the risk of embarrassment, fear or rejection, risk of being inundated from connection requests from undesirable suitors, while also reducing the amount of data associated with managing a social network account. Furthermore, by only allowing other users at the same location to view the basic profile information associated with the user, only a limited amount of users may be able to view the basic profile information of the user.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a topology for a networking application, according to an embodiment.

FIG. 2 illustrates a method allowing users to interact with other users on over a network, according to one embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

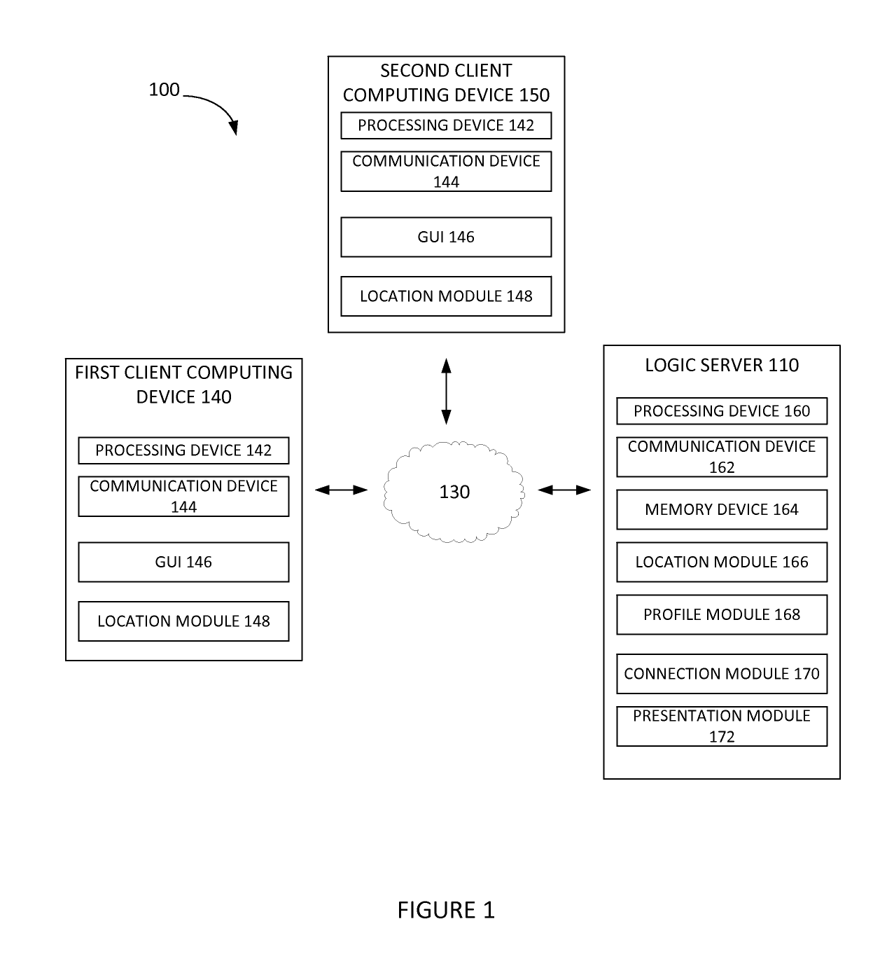

Turning now to FIG. 1, FIG. 1 depicts one topology 100 for a networking application, according to an embodiment. Topology 100 may include logic server 110, first client computing device 140, and a second client computing device 150. The elements depicted in topology 100 may be communicatively coupled to each other over network 130.

Network 130 may be a wired or wireless network such as the Internet, an intranet, a LAN, a WAN, a cellular network, a near field communication network (NFC), or another type of network. It will be understood that network 130 may be a combination of multiple different kinds of wired or wireless networks.

Logic server 110 may be a computing device, such as a general hardware platform server configured to support mobile applications, software, and the like executed on first client computing device 140 and/or second client computing device 150. Logic server 110 may include physical computing devices residing at a particular location or may be deployed in a cloud computing network environment. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Logic server 110 may include any combination of one or more computer-usable or computer-readable media. For example, logic server 110 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

In embodiments, logic server 110 may include a processing device 160, a communication device 162, a memory device 164, a location module 166, a profile module 168, a connection module 170, and a presentation module 172.

Processing device 160 may include memory, e.g., read only memory (ROM) and random access memory (RAM), storing processor-executable instructions and one or more processors that execute the processor-executable instructions. In embodiments where processing device 160 includes two or more processors, the processors may operate in a parallel or distributed manner. Processing device 160 may execute an operating system of logic server 110 or software associated with other elements of logic server 110.

Communication device 162 may be a device that allows logic server 110 to communicate with another device over network 130. Communication device 162 may include one or more wireless transceivers for performing wireless communication and/or one or more communication ports for performing wired communication. In embodiments, communication device 162 may configured to operate utilizing near field communication (NFC), wherein NFC is a standard for client computing devices 140, 150 to establish a communication with each other by client computing devices 140, 150 being in close proximity to each other.

Memory device 164 may be a device that stores data generated or received by logic server 110. Memory device 164 may include, but is not limited to a hard disc drive, an optical disc drive, and/or a flash memory drive. In embodiments, memory device 164 may be configured to store information received from first client computing device 140 and/or second client computing device 150. The information stored within memory device 164 may be accessed by processing device 160, communication device 162, and/or modules 166, 168, 170, 172. In embodiments, memory device 164 may include a database configured to store profile information associated with a user of first client computing device 140, profile information associated with a user of second client computing device 150, and/or information associated with connection requests, wherein the connection requests may include a first identifier associated with the user transmitting the request and a second identifier associated with the receiving the request.

Location module 166 may be configured to determine the locations of events, venues, sites, offices, grocery stores, etc. (referred to collectively and independent hereinafter as “location”), the location of first client computing device 140, and/or the location of second client computing device 150. Location module 166 may be configured to determine and store location data associated with a location, where the location data be represented in geographic coordinates, Cartesian coordinates, and/or a name or identifier of site. In embodiments, location module 166 may determine the location data of a location responsive to receiving location information, such as geographic coordinates, Cartesian coordinates, etc. The location data may be received from a plurality of data sources, such as third party data sources, third party mapping sources, a client computing device associated with the location, etc.

Location module 166 may determine a location information of first client computing device 140 in response to receiving information indicating that the user of first client computing device 140 desires to check-into a location, at set intervals (which may be any desired period of time e.g., every 1/10^{th} of a second, every second, every minute, every ten minutes, etc.), and/or responsive to receiving commands input by a user on a graphical user interface of first client computing device 140. Location module 166 may determine a location information of second client computing device 150 in response to receiving information indicating that the user of second client computing device 150 desires to check-into a location, at set intervals, and/or responsive to receiving commands input by a user on a graphical user interface of second client computing device 150. Location module 166 may determine the location of first client computing device 140 and/or second client computing device 150 via any known means, such as a RTLS WiFi, radar, mobile device tracking, time distance of arrival (TDOA) signals, short wave radio, Bluetooth, etc. In embodiments, location module 166 may also be configured to determine the locations of first client computing device 140 and second client computing device 150 responsive to communication device 162 determining that first client computing device 140 and second client computing device 150 can form a communication channel over a NFC protocol.

Responsive to determining the location of first client computing device 140 and/or second client computing device 150, location module 166 may store the location data associated with the location of first client computing device 140 and/or second client computing device 150 in memory device 164 along with a corresponding time stamp identifying the time that the location is determined. In embodiments, location module 166 may be configured to determine that first client computing device 140 and/or second client computing device 150 are at a location by comparing the location data received from first client computing device 140 and/or second client computing device 150 with the location data or locations stored within memory device 164. If the location data of first client computing device 140 and/or the location data of second client computing device 150 match the location data of one of the plurality of locations stored within memory device 164, then location module 166 may determine that first client computing device 140 and/or second client computing device 150 is at the location with the matching location data.

Profile module 168 may be a hardware processing device configured to receive profile information and profile settings associated with a user of first client computing device 140 and/or a user of second client computing device 150. The profile information may include a unique user identifier or login-information, a name, birthdate, gender, location, a picture of the user, contact information, demographic information, biographic information, and/or other user information. The profile settings may be associated with what information the user desires to present to other users. In embodiments, the profile settings include a first set of profile information (e.g. basic profile information) and a second set of profile information that includes more profile information than the first set of profile information. For example, the first set of profile information may include only a picture, while the second set of profile information includes the user's name, job, hobbies, contact info, etc. In embodiments, a user may desire to present the first set of profile information to users that are at the same location as the user, and the second set of profile information to another user that a connection is made with, wherein the connection request may be made responsive to the two users independently transmitting a desire to be connected with each other. Therefore, a limited set of profile information may be presented to users at the same location or proximate to the first user, and a second set of profile information may be presented to users that have formed a connection while being simultaneously present at the same location or in close proximity to one another.

Connection module 170 may be a hardware processing device configured to receive check-in requests at a location from first client computing device 140 and/or second client computing device 150, receive connection requests from first client computing device 140 and/or second client computing device 150, and transmit mutual interest communications to first client computing device 140 and/or second client computing device 150.

In embodiments, connection module 170 may receive a check-in request from first client computing device 140 and/or second client computing device 150 to check-in the user at a location or location module 166 determining the location of first client computing device 140 and/or second client computing device 150. Responsive to receiving a check-in request from a user or determining the location of a user, connection module 170 may determine profile information of other users checked into the location or in close proximity to the location.

In embodiments, connection module 170 may receive connection requests from a user of first client computing device 140 and/or a user of second client computing device 150. The connection requests may indicate that the user desires to form a connection over logic server 110 with another user at the location or who is close proximity to the user. Responsive to receiving the connection request from a first user associated with first client computing device 140 to form a connection with a second user associated with second client computing device 150, connection module 170 may store an entry memory device 164 indicating that the first user associated with client computing device 140 desires to form a connection with the second user associated with client computing device 150. The stored entry may include location information associated with the location of the first and second user, an identifier of the first user, and an identifier of the second user. Responsive to receiving a connection request from the user associated with second client computing device 150 to form a connection with the first user associated with first client computing device 140, connection module 170 may store an entry memory device 164 indicating that the second user associated with second client computing device 150 desires to form a connection with the first user associated with first client computing device 140. When connection module 170 receives a connection request from first client computing device 140 and/or second client computing device 150, connection module 170 may determine what other users have transmitted connection requests associated with the corresponding client computing device while checked into the location or in close proximity to other users.

If the user of first client computing device 140 independently transmits a connection request to connect with the second user associated with second client computing device 150, and the communication request is independently reciprocated by the second user of second client computing device 150, without knowledge of the first users connection request, connection module 170 may transmit a mutual interest communication request to first client computing device 140 and second client computing device 150. The mutual interest communication request may enable the users of first client computing device 140 and second client computing device 150 to interact with each other over network 130.

In embodiments, responsive to location module 166 determining that the user of first client computing device 140 or second client computing device 150 is no longer at the location and/or connection module 170 receives a request from first client computing device 140 and/or second client computing device 150 to check-out of the location, the users of first client computing device 140 and/or second client computing device 150 may no longer be able to interact with each other over network 130. Therefore, if the users leave the location or are no longer in close proximity to one another, the users may not be able to interact with each other or view the second set of profile information even if a mutual interest communication request is formed. Accordingly, users may be able to limit what information is presented to other users by leaving or checking out of a location.

In embodiments, if the users who have formed a mutual interest communication request check back into the location or are in close proximity to each other at a later period of time, the users may be required to independently transmit connection requests once again before interacting with each other over network 130 or viewing the other user's second set of profile information. Additionally, in embodiments, if the users check into a second location, it may be desired and/or required that the users independently transmit connection requests before interacting with each other over network 130 or view the other user's second set of profile information even if the users had independently formed a connection request at another location.

Presentation module 172 may be configured to transmit information configured to be displayed on a graphical user interface of first client computing device 140 and/or second client computing device 150. In embodiments, presentation module 172 may transmit information associated with other users' profile information that is at the same location as the user, interfaces that the user may communicate with each other, an interface that the user may enter a connection request to connect with another user at the location, and/or an indication of a mutual connection request from another user at the location. Presentation module 172 may be configured to allow users that have accepted mutual communication acceptance requests to interact with each other through interfaces within a virtual space. Such communications may include one or more of textual chat, instant messages, private messages, voice communications, and/or other communications. Communications may be received and entered by the users via their respective client computing devices 140, 150. Presentation module 172 may route communications to and from the appropriate users through logic server 110.

Client computing devices 140 and 150 may be a smart phone, tablet computer, laptop computer, wearable computer, personal data assistant, or any other type of mobile device with a hardware processor that is configured to process instructions and connect to network 130, one or more portions of network 130. Client computing devices 140, 150 may include processing device 142, communication device 144, graphical user interface (GUI) 146, and client location module 148.

Processing device 142 may include memory, e.g., read only memory (ROM) and random access memory (RAM), storing processor-executable instructions and one or more processors that execute the processor-executable instructions. In embodiments where processing device 142 includes two or more processors, the processors may operate in a parallel or distributed manner. Processing device 142 may execute an operating system of client computing devices 140, 150 or software associated with other elements of client computing devices 140, 150.

Communication device 144 may be a device that allows client computing devices 140, 150 to communicate with another device over network 130. Communication device 144 may include one or more wireless transceivers for performing wireless communication and/or one or more communication ports for performing wired communication. In embodiments, communication device 144 may be configured to transmit a check-in request, a connection request, and/or a mutual interest request over network 130. In embodiments, communication device 144 may configured to operate utilizing near field communication (NFC), wherein NFC is a standard for client computing devices 140, 150 to establish a communication with each other by client computing devices 140, 150 being in close proximity to each other.

GUI 146 may be a device that allows a user to interact with client computing devices 140, 150. While one GUI is shown, the term “graphical user interface” may include, but is not limited to being, a touch screen, a physical keyboard, a mouse, a camera, a video camera, a microphone, and/or a speaker. GUI 146 may be configured to receive inputs, including audio and/or visual data, associated with notes, markers, keywords, schedule, performance history, settings, etc. The received inputs may be transmitted to logic server 110 over network 130. GUI 146 may also be configured to transmit information associated with a user's profile, display profile information of other user's at the location, display an icon to transmit a connection request, allow the user to check-into or check-out of a location, interact with another user over network 130, etc.

Client location module 148 may be configured to determine a location of a client computing device 140, 150. In embodiments, client location module 148 may be configured to continuously determine the location data associated with the location of client computing device 140, in response to a user desiring to check-into a location, in response to a user desiring to check-out of a location, and/or in response to receiving commands from the user on GUI 146. Client location module 148 may be configured to transmit the determined location data to logic server 110. The location data may be associated with and represented in geographic coordinates, Cartesian coordinates, and/or a name restaurant. The location data may include information such as real-time locating system signals (RTLS), WiFi signals, GPS, Bluetooth, short range radio signals, etc.

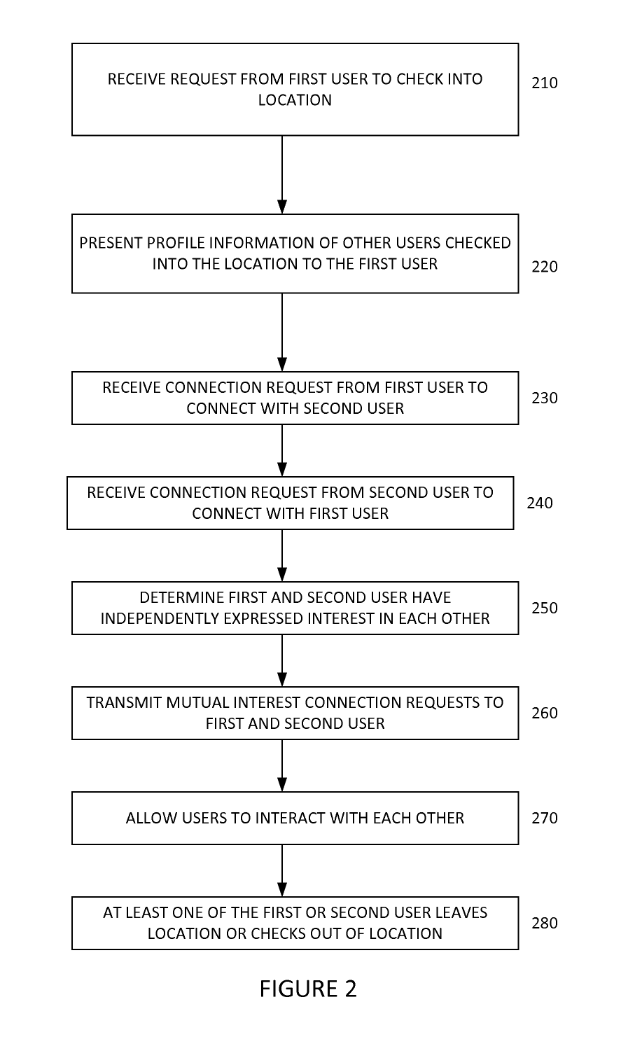

FIG. 2 illustrates a method 200 allowing users to interact with other users on over a network. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described below is not intended to be limiting.

In some embodiments, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

At operation 210, a request for a user of a first client computing device to check-in to a location or information determining the location of a first client computing device may be received. The request or information may be received responsive to the user performing actions on the first client computing device to select the location or based on automatically determining the location of the first client computing device. In embodiments, the user may check into a location by selecting a list of locations presented to the user on a graphical user interface of the first client computing device, the user free-from typing entering the name of the location, or via any other known method of checking into a location. In embodiments, it may be required or desired for the user to be at located at the location for the user to check-into the location. In other embodiments, the location of first client computing device may be determined by comparing the location information associated with the first client computing device and location information associated with locations. If the location information matches, then it may be determined that the first client computing device is at the location Operation 210 may be performed by a connection module that is the same as or similar to connection module 170, in accordance with one or more implementations.

At operation 220, responsive to receiving the request to check-into a location from the first client computing device, profile information of other users checked into the location or located in close proximity to the location may be presented to the user on first client computing device. The profile information presented to the user may be a limited view of the profile information of the other users at the location, wherein the limited view of the profile information may include a first set of profile information but may not include a second set of profile information. Furthermore, the user of first client computing device may not be able to interact with the other users at the location. Operation 220 may be performed by a presentation module that is the same as or similar to presentation module 172, in accordance with one or more implementations.

At operation 230, a connection request may be received from the first client computing device indicating that the user of the first client computing device desires to communicate with a second user checked into the location or in close proximity to the location. The connection request may be transmitted in response to the user of the first client computing device performing actions on the first client computing device to generate the connection request. Operation 230 may be performed by a connection that is the same as or similar to connection module 170, in accordance with one or more implementations.

At operation 240, a second connection request may be received from a second client computing device indicating that the user of the second client computing device desires to interact with the user of the first client computing device. The second connection request may be transmitted in response to the user of the second client computing device performing actions on the second client computing device to generate the connection request. Additionally, the second connection request may be transmitted by the second user without the second user's knowledge that the first user transmitted the connection request at operation 230. Operation 240 may be performed by a connection that is the same as or similar to connection module 170, in accordance with one or more implementations.

At operation 250, responsive to receiving the second connection request at operation 240, it may be determined that the users of the client computing devices at the location have independently expressed interest in each other, without the other user's knowledge. Operation 250 may be performed by a connection module that is the same as or similar to connection module 170, in accordance with one or more implementations.

At operation 260, a mutual interest connection requests may be transmitted to the users of the first client computing device and the second computing device, indicating that both of the users of the client computing devices have independently expressed interest in each other. In embodiments, the mutual interest connection request may identify that both of the users have performed a double blind test resulting in an indication that they are interested in each other. The mutual interest connection request may include an identifier of the other individual and the second set of profile information, such as the individuals name, picture, a portion of the users profile information, etc. Operation 260 may be performed by a connection module that is the same as or similar to connection module 170, in accordance with one or more implementations.

At operation 270, responsive to receiving an indication that the user of the first client computing device and the second client computing device have accepted the mutual interest connection request on their respective client computing devices, the users may be able to interact with each other while they are located at the location and/or checked into the location. Additionally, responsive to receiving the acceptances of the mutual interest connection request, the second set of profile information corresponding to the first and user may be presented to the first and second user. In embodiments, the second set of profile information may include more profile information than the limited profile information presented at operation 220. Operation 270 may be performed by a presentation module 172 that is the same as or similar to presentation module 172, in accordance with one or more implementations.

At operation 280, at least one of the users of the first client computing device or the second client computing device may check out of the location and/or it may be determined that the at least one user is no longer at the location. Responsive to the first user checking out of the location or no longer being at the location, the second user may no longer be able to interact with the first user. Furthermore, if the first user checks out of the location or relocates, then the first users profile information may no longer be visible to the other users at the location, including the second user. Operation 280 may be performed by a presentation module 172 that is the same as or similar to presentation module 172, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system for determining mutual interest among users, the system comprising:
a location module configured to determine that a first client computing device and a second client computing device are at a location, wherein the first client computing device is associated with a first user and the second client computing device is associated with a second user;
a profile module configured to receive information corresponding to a profile of the first user and the second user, wherein the profile includes a first set of profile information and a second set of profile information;
a connection module configured to receive a first connection request from the first client computing device and a second connection request from the second client computing device, and the connection module configured to transmit a mutual connection request to the first client computing device and the second client computing device responsive to receiving the first connection request and the second connection request while the first client computing device and the second client computing device are at the location, wherein the first connection request and the second connection request are transmitted independently from one another; and
a presentation module configured to transmit the first set of information within the profile associated with the second user responsive to determining that the first client computing device and second client computing device are at the location, and the presentation module is configured to transmit the second set of profile information within the profile associated with the second user responsive to transmitting the mutual connection request.

2. The system of claim 1, wherein the second client computing device can not present any of the profile information associated with the first user responsive to the location module determining that the first client computing device has left the first location.

3. The system of claim 1, wherein the first client computing device and the second client computing device are able to communicate with each other responsive to the connection module transmitting the mutual connection.

4. The system of claim 1, wherein the first connection request indicates that the first user desires to interact with the second user, and the second connection request indicates that the second user desires to interact with the first user.

5. The system of claim 4, wherein the presentation module is configured to transmit an anonymous notification to the second computing device indicating that a user at the location has transmitted a connection request to interact with the second user responsive to receiving the first connection request.

6. The system of claim 5, wherein the anonymous notification does not identify the first user.

7. The system of claim 1, wherein the first set of profile information associated with the first user includes a picture of the first user, and the second set of profile information associated with the first user includes a name of the first user.

8. The system of claim 1, wherein if the first client computing device and the second client computing device receive a first a mutual connection request while the first client computing device and second client computing device are at a first location and the first client computing device are later at a second location, a second mutual connection request is required to be transmitted for the first computing device and the second computing device to interact with each other at the second location.

9. The system of claim 1, wherein the location of the first client computing device and the second client computing device is determined using near field communication technology.

10. The system of claim 9, wherein the location module is configured to determine that the first client computing device and the second client computing device are at the location if the first client computing device and second client computing device are proximately located.

11. A method for determining mutual interest among users, the method comprising:
determining that a first client computing device and a second client computing device are at a location, wherein the first client computing device is associated with a first user and the second client computing device is associated with a second user;
receiving information corresponding to a profile of the first user and the second user, wherein the profile includes a first set of profile information and a second set of profile information;
transmitting the first set of information within the profile associated with the second user responsive to determining that the first client computing device and second client computing device are at the location;
receiving a first connection request from the first client computing device and a second connection request from the second client computing device;
transmitting a mutual connection request to the first client computing device and the second client computing device responsive to receiving the first connection request and the second connection request while the first client computing device and the second client computing device are at the location, wherein the first connection request and the second connection request are transmitted independently from one another; and
transmitting the second set of profile information within the profile associated with the second user responsive to transmitting the mutual connection request.

12. The method of claim 11, wherein the second client computing device can not present any of the profile information associated with the first user responsive to the determining that the first client computing device has left the first location.

13. The method of claim 11, wherein the first client computing device and the second client computing device are able to communicate with each other responsive to the connection module transmitting the mutual connection.

14. The method of claim 11, wherein the first connection request indicates that the first user desires to interact with the second user, and the second connection request indicates that the second user desires to interact with the first user.

15. The method of claim 14, further comprising:
transmitting an anonymous notification to the second computing device indicating that a user at the location has transmitted a connection request to interact with the second user responsive to receiving the first connection request.

16. The method of claim 15, wherein the anonymous notification does not identify the first user.

17. The method of claim 11, wherein the first set of profile information associated with the first user includes a picture of the first user, and the second set of profile information associated with the first user includes a name of the first user.

18. The method of claim 11, further comprising:
determining the first client computing device and the second client computing device have received a first a mutual connection request while the first client computing device and second client computing device are at a first location;
determining that the first client computing device are at a second location; and
requiring a second mutual connection request to be transmitted for the first computing device and the second computing device to interact with each other at the second location.

19. The method of claim 11, wherein the location of the first client computing device and the second client computing device is determined using near field communication technology.

20. The method of claim 19, further comprising:
determining that the first client computing device and the second client computing device are at the location if the first client computing device and second client computing device are proximately located.
